(19) United States
(12) Patent Application Publication
(10) Pub. No.: US 2009/0267874 A1
(43) Pub. Date: Oct. 29, 2009

(54) ACTIVE MATRIX TYPE DISPLAY APPARATUS

(76) Inventor: Norio NAKAMURA, Kanazawa-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/427,282

(22) Filed: Apr. 21, 2009

(30) Foreign Application Priority Data
Apr. 25, 2008 (JP) 2008-115801

(51) Int. Cl. G09G 3/30

(52) U.S. Cl. 345/76

(57) ABSTRACT

An active matrix type display apparatus includes a plurality of pixels arranged in a matrix on a substrate, each pixel including, a display element, a driving transistor which controls the light emitting current, a first capacitor, a second capacitor, a first switch which is on/off controlled by a first control signal, a second switch which is on/off controlled by a second control signal, a third switch which is on/off controlled by a third control signal, a fourth switch which is on/off controlled by a fourth control signal, and a fifth switch which is on/off controlled by a fifth control signal, and at least one power source which is disposed arbitrarily separately to correspond to a light emission color assigned to the display element and is connected to the high potential power source line.

### CROSS-REFERENCE TO RELATED APPLICATIONS

This application is based upon and claims the benefit of priority from prior Japanese Patent Application No. 2008-115801, filed Apr. 25, 2008, the entire contents of which are incorporated herein by reference.

### BACKGROUND OF THE INVENTION

1. Field of the Invention

The present invention relates to an active matrix type display apparatus, and more particularly to a low-power, active matrix type display apparatus.

2. Description of the Related Art

U.S. Pat. No. 6,373,454 discloses an active matrix type organic EL display apparatus adopting current copy type circuits serving as pixel circuits. In this display apparatus, a current signal serving as an image signal is supplied to each pixel, and a driving current with a magnitude corresponding to this current signal is caused to flow in the organic EL element; thereby the organic EL element emits light. This technology reduces the effect of variation in the characteristics of driving transistors on the magnitude of the driving current.

The active matrix type display apparatus described in U.S. Pat. No. 6,373,454 is configured such that a high potential power source used to drive organic EL elements is shared between the colors R, G, and B. In order to cope with different voltage decreases in the respective organic EL elements for R, G, and B when emitting light at maximum luminance, the high power source potential is determined based on the color in the organic EL element with the greatest voltage decrease.

Jpn. Pat. Appln. KOKAI Publication No. 2005-326830 discloses an organic EL display apparatus that suppresses power loss in a driving transistor, thereby reducing heat generation of the display apparatus or power consumption. In this display apparatus, the high potential power sources for driving the organic EL elements are provided independently of one another for the respective colors, R, G, and B.

### BRIEF SUMMARY OF THE INVENTION

An active matrix type display apparatus according to a first aspect of the present invention comprises: a plurality of pixels arranged in a matrix on a substrate, each pixel comprising: a display element which is connected between a low potential power source line and a high potential power source line and emits light according to a light emitting current supplied to the display element; a driving transistor which is connected between the high potential power source line and the display element and controls the light emitting current supplied to the display element according to a gate control voltage; a first capacitor which is connected between a gate of the driving transistor and a first end of a current path of the driving transistor; a second capacitor, a first end of an electrode of which is connected to the gate of the driving transistor; a first switch which is connected between a second end of the electrode of the second capacitor and a reset line used for resetting the pixel and is on/off controlled by a control signal from a first control signal line used for controlling the pixel; a second switch which is connected between the first end of the electrode of the second capacitor and the reset line and is on/off controlled by a control signal from a second control signal line used for controlling the pixel; a third switch which is connected between the second end of the electrode of the second capacitor and an image signal line used for supplying the pixel with a signal corresponding to an image signal and is on/off controlled by a control signal from a third control signal line used for controlling the pixel; a fourth switch which is connected between the gate of the driving transistor and a second end of the current path of the driving transistor and is on/off controlled by a control signal from a fourth control signal line used for controlling the pixel; and a fifth switch which is connected between the second end of the current path of the driving transistor and the display element and is on/off controlled by a control signal from a fifth control signal line used for controlling the pixel; and at least one power source which is disposed arbitrarily separately to correspond to a light emission color assigned to the display element and is connected to the high potential power source line.

An active matrix type display apparatus according to a second aspect of the present invention comprises: a plurality of pixels arranged in a matrix on a substrate, each pixel comprising: a display element which is connected between a low potential power source line and a high potential power source line and emits light according to a light emitting current supplied to the display element; a driving transistor which is connected between the high potential power source line and the display element and controls the light emitting current supplied to the display element according to a gate control voltage; a first capacitor which is connected between a gate of the driving transistor and a first end of a current path of the driving transistor; a second capacitor, a first end of an electrode of which is connected to the gate of the driving transistor; a first switch which is connected between a second end of the electrode of the second capacitor and a reset line used for resetting the pixel and is on/off controlled by a control signal from a first control signal line used for controlling the pixel; a second switch which is connected between the first end of the electrode of the second capacitor and the reset line and is on/off controlled by a control signal from a second control signal line used for controlling the pixel; a third switch which is connected between the second end of the electrode of the second capacitor and an image signal line used for supplying the pixel with a signal corresponding to an image signal and is on/off controlled by a control signal from a third control signal line used for controlling the pixel; a fourth switch which is connected between the gate of the driving transistor and a second end of the current path of the driving transistor and is on/off controlled by a control signal from a fourth control signal line used for controlling the pixel; and a fifth switch which is connected between the second end of the current path of the driving transistor and the display element and is on/off controlled by a control signal from a fifth control signal line used for controlling the pixel; and at least two power sources which are disposed separately, one of the power sources corresponding to one light emission color assigned to the display element and the other one corresponding to the other light emission colors assigned to the other display elements and which are connected to the two high potential power source lines separately.

An active matrix type display apparatus according to a third aspect of the present invention comprises: a plurality of pixels arranged in a matrix on a substrate, each pixel comprising: a display element which is connected between a low potential power source line and a high potential power source line and emits light according to a light emitting current supplied to the display element; a driving transistor which is connected between the high potential power source line and the display element and controls the light emitting current supplied to the display element according to a gate control voltage; a first capacitor which is connected between a gate of the driving transistor and a first end of a current path of the driving transistor; a second capacitor, a first end of an electrode of which is connected to the gate of the driving transistor; a first switch which is connected between a second end of the electrode of the second capacitor and a reset line used for resetting the pixel and is on/off controlled by a control signal from a first control signal line used for controlling the pixel; a second switch which is connected between the first end of the electrode of the second capacitor and the reset line and is on/off controlled by a control signal from a second control signal line used for controlling the pixel; a third switch which is connected between the second end of the electrode of the second capacitor and an image signal line used for supplying the pixel with a signal corresponding to an image signal and is on/off controlled by a control signal from a third control signal line used for controlling the pixel; a fourth switch which is connected between the gate of the driving transistor and a second end of the current path of the driving transistor and is on/off controlled by a control signal from a fourth control signal line used for controlling the pixel; and a fifth switch which is connected between the second end of the current path of the driving transistor and the display element and is on/off controlled by a control signal from a fifth control signal line used for controlling the pixel; and a power source which is shared between the light emission colors assigned to the corresponding display elements and is connected to the high potential power source line.

An active matrix type display apparatus according to a fourth aspect of the present invention comprises: a plurality of pixels arranged in a matrix on a substrate, each pixel comprising: a display element which is connected between a low potential power source line and a high potential power source line and emits light according to a light emitting current supplied to the display element; a driving transistor which is connected between the high potential power source line and the display element and controls the light emitting current supplied to the display element according to a gate control voltage; a first capacitor which is connected between a gate of the driving transistor and a first end of a current path of the driving transistor; a second capacitor, a first end of an electrode of which is connected to the gate of the driving transistor; a first switch which is connected between a second end of the electrode of the second capacitor and a reset line used for resetting the pixel and is on/off controlled by a control signal from a first control signal line used for controlling the pixel; a second switch which is connected between the first end of the electrode of the second capacitor and the reset line and is on/off controlled by a control signal from a second control signal line used for controlling the pixel; a third switch which is connected between the second end of the electrode of the second capacitor and an image signal line used for supplying the pixel with a signal corresponding to an image signal and is on/off controlled by a control signal from a third control signal line used for controlling the pixel; a fourth switch which is connected between the gate of the driving transistor and a second end of the current path of the driving transistor and is on/off controlled by a control signal from a fourth control signal line used for controlling the pixel; and a fifth switch which is connected between the second end of the current path of the driving transistor and the display element and is on/off controlled by a control signal from a fifth control signal line used for controlling the pixel; and a plurality of power sources which are provided separately to correspond to light emission colors assigned to the corresponding display elements and are connected to the corresponding high potential power source lines.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram of an active matrix type display apparatus according to an embodiment of the present invention;

FIG. 2 shows the configurations of pixel circuits according to the embodiment of the present invention;

FIG. 3 is a time chart showing the state of each of a plurality of switches in a series of operations performed by the active matrix type display apparatus according to the embodiment of the present invention;

FIG. 4 is a sectional view of the structure of a driving thin film transistor DTr and an organic EL element OLED;

FIG. 5 is a conceptual diagram illustrating a case where there are differences between R, G, and B in the degree of voltage decrease in the organic EL element;

FIG. 6 is a conceptual diagram showing the light emission characteristics when a common high potential power source line is connected to the respective pixel circuits for R, G, and B;

FIG. 7 is a diagram showing the configurations of conventional pixel circuits in which the common high potential power source line is connected to the respective pixel circuits for R, G, and B;

FIG. 8 is a conceptual diagram illustrating the light emission characteristics of the organic EL elements in the pixel circuits in the present embodiment; and

FIG. 9 shows the configuration of pixel circuits in which high potential power source lines are connected to the pixel circuits for the respective light emission colors R, G, and B.

### DETAILED DESCRIPTION OF THE INVENTION

Embodiments according to the present invention will hereinafter be described with reference to the accompanying drawings. Note that in these drawings, compositional elements that have the same or substantially the same function are denoted with the same reference numerals and a repeated explanation of these elements is omitted.

Below is the description of an organic EL display apparatus from among a number of active matrix display apparatuses. However, the present invention is not limited to the organic EL display apparatus.

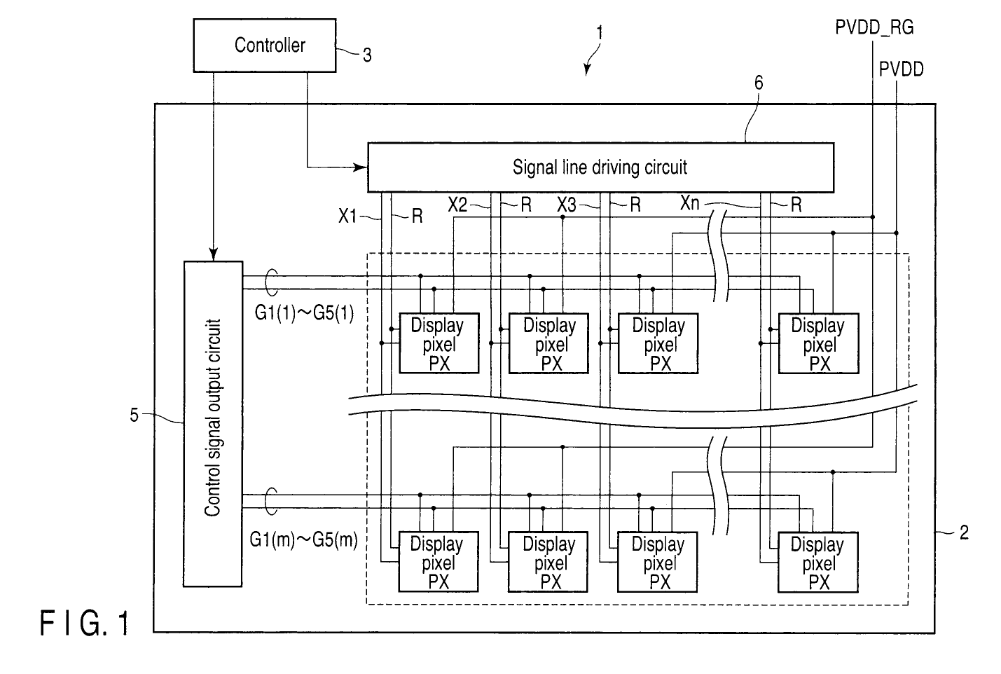

As shown in FIG. 1, the organic EL display apparatus includes an organic EL panel 1 and a controller 3 for controlling the organic EL panel 1.

The organic EL panel 1 includes: a number (m×n) of display pixels PX arranged in a matrix on a transparent insulation substrate 2 such as a glass plate, thereby composing a display area 7; a number m of first control signal lines G1 (1 to m), m second control signal lines G2 (1 to m), m third control signal lines G3 (1 to m), m fourth control signal lines G4 (1 to m), and m fifth control signal lines GS (1 to m). The first to fifth control signal lines G1 to G5 are independent from one another and connected to the corresponding rows of display pixels.

The organic EL panel 1 also includes a number n of signal lines X1 to Xn, n reset lines R, a control signal output circuit 5, a signal line driving circuit 6, and a power source line.

The number n of signal lines X1 to Xn are connected to the corresponding columns of display pixels. The number n of reset lines R are also connected to the corresponding columns of display pixels. The control signal output circuit 5 controls the drive of the control signal lines G1 to G5. The signal line driving circuit 6 drives the signal lines X1 to Xn and the reset lines R. The power source line supplies the display pixels PX with high potentials PVDD and PVDD_RG.

The high potential PVDD is supplied to the blue display pixels PX, and high potential PVDD_RG is supplied to the red and green display pixels PX. Reset voltages Vref supplied to the reset lines R are supplied from a common voltage source (not shown).

Connected to the signal line driving circuit 6 are signal lines X1, X2, X3, etc., which are provided for the corresponding columns of pixels. As shown in FIG. 1, the signal lines X1, X2, etc., extend along the corresponding columns of display pixels PX (i.e., in direction Y). These signal lines X1, X2, etc., are connected to the signal line driving circuit 6 and the corresponding columns of display pixels PX.

Connected to the control signal output circuit 5 are the control signal lines G1 to G5 provided for corresponding rows of pixels. As shown in FIG. 1, the control signal lines G1 to G5 extend along corresponding rows of display pixels PX (i.e., in direction X). These control signal lines G1 to G5 are connected to the control signal output circuit 5 and the corresponding rows of display pixels X.

The control signal output circuit 5 and signal line driving circuit 6 are driven by timing pulses from the controller 3. A timing signal and a clock signal synchronized with an image signal are supplied to this controller 3 via an input terminal (not shown). Accordingly, the controller 3 is capable of supplying the control signal output circuit 5 and signal line driving circuit 6 with various timing pulses synchronized with image signals.

Connected to each of the display pixels PX is the power source line for supplying power thereto. Other power source lines (not shown) are also connected to the control signal output circuit 5, signal line driving circuit 6, and controller 3 in order to supply power thereto.

The control signal output circuit 5, signal line driving circuit 6, and controller 3 may be formed on the substrate 2 or may be provided in the form of an external IC, which is disposed outside the substrate 2.

Next, an operation of the organic EL display apparatus will be roughly described.

For convenience of description, the first to fifth control signal lines may also be called “control signal line G”. Operation of the first to fifth control signal lines will be described in detail later.

In order to store image signals, the control signal output circuit 5 selects a plurality of display pixels PX arranged in rows (i.e., in direction X). When the control signal output circuit 5 selects any one of the control signal lines G(1), G(2), . . . , G(m) and makes it active, the plurality of display pixels PX to be connected to the active control signal line G are able to store image signals.

The signal line driving circuit 6 receives image signals via an input terminal (not shown). The image signals received are converted into image signals for the corresponding display pixels PX in rows (i.e., in direction X), and the image signals are output to corresponding signal lines X1, X2, etc. The active display pixels PX receive and store the image signals via the corresponding signal lines X1, X2, etc.

When image signals required for the nth line are supplied to the corresponding display pixels PX of the nth line via the corresponding signal lines X1, X2, etc., image signals required for the next line, i.e., the n+1-th line, are supplied to the display pixels PX of the n+1-th line via the corresponding signal lines X1, X2, etc. The control signal output circuit 5 selects from among the control signal lines G(1), G(2), etc.

Further, the control signal output circuit 5 activates the control signal line G, and exerts control so as to cause a light emitting current corresponding to the image signal stored in each display pixel PX to be supplied to the organic EL element.

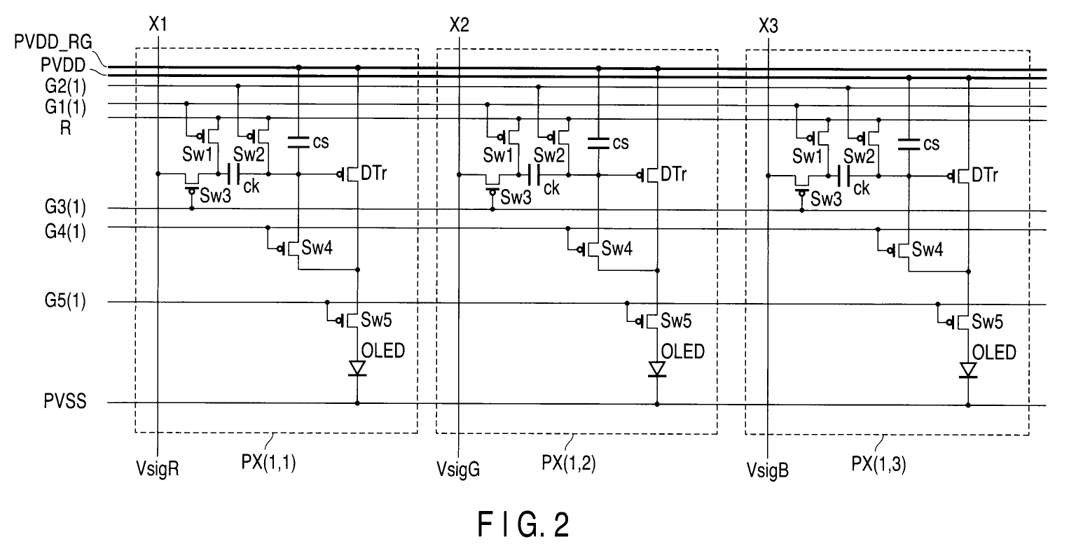

FIG. 2 is a schematic diagram of the circuit in the display pixel PX. In FIG. 2, display pixels PX(1, 1), PX(1, 2), and PX(1, 3) for red, green, and blue respectively are arranged in a specific order. This pixel circuit is of a voltage signal system that controls light emission of an organic EL element OLED according to an image signal composed of a voltage signal.

A description will be given below taking the display pixel PX (1, 3) connected to the signal line X3 as a representative example.

The pixel circuit of the display pixel PX (1, 3) includes an organic EL element OLED, a driving thin film transistor DTr, a capacitor reset switch SW1, a driving thin film transistor DTr gate reset switch SW2, a pixel selection switch SW3, a correcting switch SW4, an output switch SW5, a first capacitor Cs and a second capacitor Ck. The driving thin film transistor DTr, capacitor reset switch SW1, driving thin film transistor DTr gate reset switch SW2, pixel selection switch SW3, correcting switch SW4, and output switch SW5 are each composed of a thin film transistor of the same conductive type (e.g., P-channel type).

The organic EL element OLED is a display element with a photoactive layer between a pair of opposite electrodes. The cathode of the organic EL element OLED is connected to a low potential power source line (PVSS) of low potential PVSS, and its anode is connected to a high potential power source line (PVDD) of high potential PVDD, via a circuit used for driving this element.

In order to distinguish one power source line from the other, each power source line may hereinafter be described together with its potential in brackets.

The driving thin film transistor DTr, output switch SW5, and organic EL element OLED are connected in series between the high potential power source line PVDD and low potential power source line PVSS. The source of the driving thin film transistor DTr is connected to the high potential power source line PVDD. A source of the output switch SWS is connected to the drain of the driving thin film transistor DTr. A drain of the output switch SW5 is connected to the anode of the organic EL element OLED. A gate of the output switch SW5 is connected to the signal control line G5.

The driving thin film transistor DTr outputs a signal current corresponding to an image signal to the organic EL element OLED. The output switch SW5 is on (conductive state)/off (non-conductive state) controlled by a control signal from the signal control line G5, thereby controlling the connection/disconnection between the driving thin film transistor DTr and the organic EL element OLED.

The first capacitor Cs is connected to the source and gate of the driving thin film transistor DTr, and holds the gate control potential of the driving thin film transistor DTr determined by an image signal. The first capacitor Cs has a pair of opposite plate-like electrodes in parallel. In this embodiment, the gate electrode film of the driving thin film transistor DTr and a polysilicon layer together form a parallel-plate capacitor.

The pixel selection switch SW3 is connected to the corresponding signal line X3 and the gate of the driving thin film transistor DTr via the second capacitor Ck. The gate of the switch SW3 is connected to the signal control line G3. The pixel selection switch SW3 is on (conductive state)/off (non-conductive state) controlled in response to a control signal supplied from the signal control line G3, and receives an image signal from the corresponding signal line X1. That is, the second capacitor Ck AC-couples the image signal to the gate of the driving thin film transistor DTr.

The correcting switch SW4 is connected to the drain and gate of the driving thin film transistor DTr, and the gate of the switch SW4 is connected to the signal control line G4. The correcting switch SW4 is on (conductive state)/off (non-conductive state) controlled in response to a control signal supplied from the signal control line G4, and controls the connection or disconnection between the gate and drain of the driving thin film transistor DTr.

The capacitor reset switch SW1 is connected to the reset line R and one end of the second capacitor Ck, and its gate is connected to the signal control line G1. The capacitor reset switch SW1 is on (conductive state)/off (non-conductive state) controlled in response to a control signal supplied from the signal control line G1, and controls the connection or disconnection between the reset line R and one end (first end) of the second capacitor Ck.

The driving thin film transistor DTr gate reset switch SW2 is connected to the reset line R and the other end (second end) of the second capacitor Ck, and its gate is connected to the signal control line G2. The driving thin film transistor DTr gate reset switch SW2 is on (conductive state)/off (non-conductive state) controlled in response to a control signal supplied from the signal control line G2, and controls the connection or disconnection between the reset line R and the other end of the second capacitor Ck.

In this embodiment, all the thin film transistors composing the pixel circuit are formed by the same process so as to have the same layer structure, namely a top gate structure including a semiconductor layer formed from polysilicon. Composing the pixel circuit from identical conduction type thin film transistors keeps manufacturing costs low.

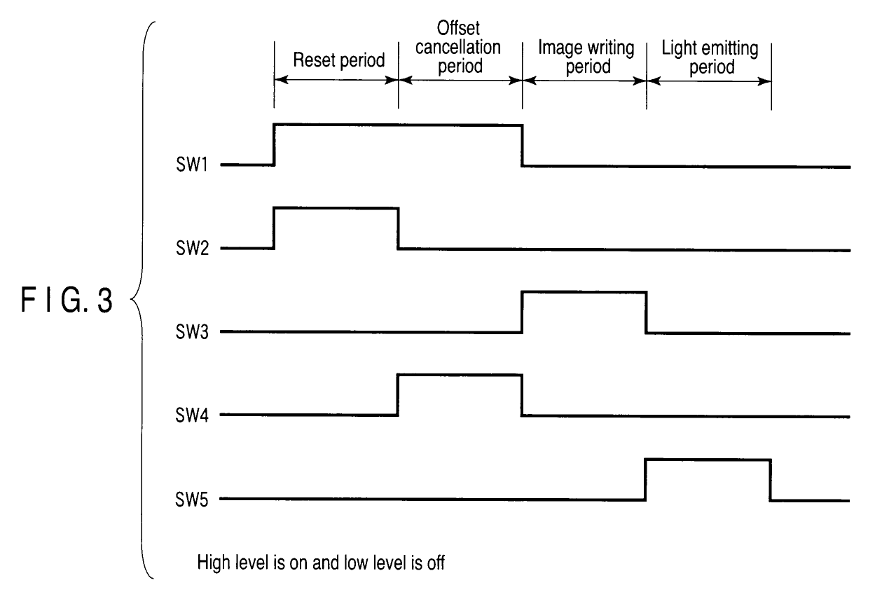

FIG. 3 is a time chart showing the state of each of the switches in a series of operations performed by the active matrix type display apparatus in the embodiment of the present invention. Referring to FIGS. 2 and 3, operations of the pixel circuit will now be described.

As shown in FIG. 3, operation of the active matrix type display apparatus according to the embodiment of the present invention is roughly divided into four periods: a reset period, an offset cancellation period, an image writing period, and a light emitting period.

In the reset period, both the capacitor reset switch SW1 and the driving thin film transistor DTr gate reset switch SW2 are turned on. Consequently, a potential Vref is applied to both ends of the second capacitor Ck from the reset line R, and the second capacitor Ck is thereby reset.

Since the driving thin film transistor DTr gate reset switch SW2 is turned on at this time, the gate potentials of the driving thin film transistor DTr and the first capacitor Cs are also reset.

In the offset cancellation period, the driving thin film transistor DTr gate reset switch SW2 is turned off. Also, the correcting switch SW4 is turned on, which brings the driving thin film transistor DTr into a diode connection whereby the gate and drain are connected.

As a result, a current flows from the power source line PVDD along the path of the source, drain, and gate of the driving thin film transistor DTr, and hence a voltage corresponding to the threshold voltage Vth of the driving thin film transistor DTr is held in the first capacitor Cs and second capacitor Ck.

In this case, in order to cause the current to flow, the reset voltage Vref is lower than the voltage obtained by subtracting the threshold voltage Vth of the driving thin film transistor DTr from the power source line PVDD.

In an image writing period, the capacitor reset switch SW1 and the correcting switch SW4 are turned off, and the pixel selection switch SW3 is turned on. Consequently, an image signal voltage VsigB is applied to one end of the second capacitor Ck via the signal line X3. As a result, the gate potential of the driving thin film transistor DTr changes only by a voltage corresponding to the second capacitor-first capacitor ratio of the difference in voltage between the image signal voltage VsigB and the reset voltage in the second capacitor Ck. Accordingly, the gate potential of the driving thin film transistor DTr is maintained at the value where the potential corresponding to the image signal voltage VsigB is added to the potential held in an offset cancellation period.

By writing images in such a manner after offset cancellation, any offset caused by variation in the threshold of the driving thin film transistor DTr can be canceled.

In the light emitting period, the pixel selection switch SW3 is turned off and the output switch SW5 is turned on. Consequently, a light emission current corresponding to a voltage between the gate and source of the driving thin film transistor DTr flows in the organic EL element OLED. As a result, the organic EL element OLED emits light with a luminance corresponding to the light emission current.

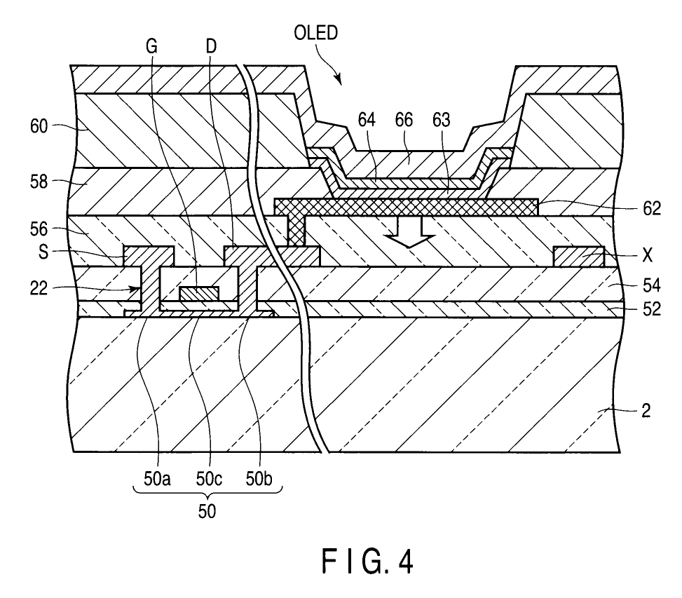

FIG. 4 is a sectional view of the structure of the driving thin film transistor DTr and organic EL element OLED.

The P-channel type thin film transistor in which the driving thin film transistor DTr is formed has a semiconductor layer 50 of polysilicon, formed on an insulation substrate 2. This semiconductor layer has a source area 50a, a drain area 50b, and a channel area 50c located between the source and drain areas. A gate insulation film 52 is laid over the semiconductor layer 50. A gate electrode G is disposed on the gate insulation film and opposite the channel area 50c. An inter-layer insulation film 54 is laid over the gate electrode G. On the inter-layer insulation film are a source electrode S and a drain electrode D.

The source electrode S and drain electrode D are connected to the source area 5 0a and drain area 50b, respectively, in the semiconductor layer 50 via contacts formed through both the inter-layer insulation film 54 and gate insulation film 52.

Disposed on the inter-layer insulation film 54 are a plurality of wires including the image signal wires X. Formed on the inter-layer insulation film 54 is a protective film 56 covering the source electrode S, drain electrode D, and wiring. Formed on the protective film 56 are a hydrophilic film 58 and a partition film 60 layered in that order.

The organic EL element OLED has a structure in which an organic light emitting layer 64 containing a luminescent organic compound is sandwiched between an anode 62 and a cathode 66. The anode 62 is formed from a transparent electrode material such as ITO (Indium Tin Oxide) and disposed on the protective film 56. In the hydrophilic film 58 and partition film 60, areas corresponding to the anode 62 are removed by etching. Formed on the anode 62 are an anode buffer layer 63 and an organic light emitting layer 64. Further, the cathode 66, of barium aluminum alloy, is formed on the organic light emitting layer 64 and partition film 60 in layers.

In an organic EL element OLED with the foregoing structure, holes injected from the anode 62 and electrons injected from the cathode 66 are re-bonded within the organic light emitting layer 64 and, as a result, organic molecules composing the organic light emitting layer are excited to produce excitons. These excitons emit light in the process of radiation inactivation. This light is emitted outside from the organic light emitting layer 64 through the transparent anode 62 and insulation substrate 2.

The description above of the pixel circuit shown in FIG. 2 takes the case where the anode 62 of the organic EL element OLED is connected to a high potential power source line (PVDD) via the P-channel type driving thin film transistor DTr, and the cathode 66 to the low potential power source line (PVSS). However, the cathode 66 may be connected to the high potential power source line (PVDD) via the drain of the driving thin film transistor DTr, and the anode 62 to the low potential power source line (PVSS). In both cases, it is necessary for the light emission face to be formed of a transparent conductive material. For example, when the cathode 66 is disposed on the light emission face side, this is achieved by rendering an alkali earth metal or rare-earth metal sufficiently thin as to allow the passage of light.

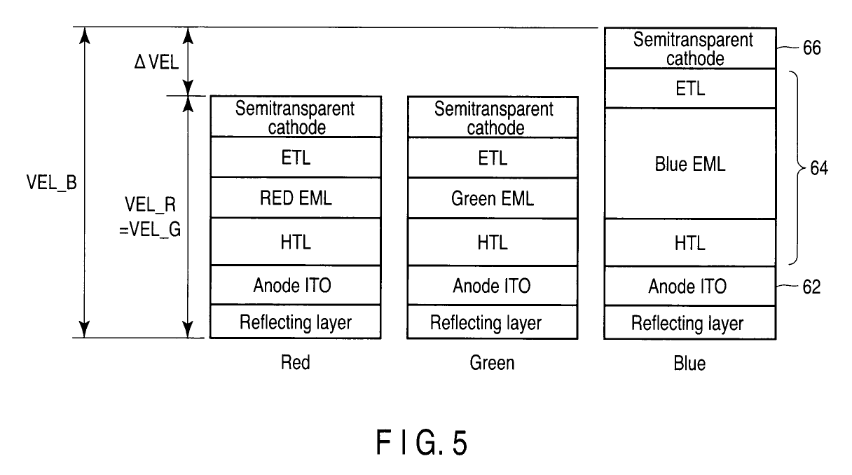

FIG. 5 is a conceptual diagram illustrating a case where there are differences between R, G, and B in the degree of voltage decrease in the organic EL element.

FIG. 5 shows the structures of organic EL elements corresponding to R, G, and B. As described above, each of the organic EL elements OLED includes: an ITO composing an anode 62; an organic light emitting layer 64; a semitransparent cathode 66, and a reflecting layer. The organic light emitting layer 64 includes an electron transport layer (ETL), a light emitting layer (EML) for the respective colors (R, G, B), and an electron hole transport layer (HTL).

Indicated vertically in FIG. 5 are voltages applied to both ends of each of the organic EL elements OLED in order to generate the light emission luminance required for red (R), green (G) or blue (B). It is found that the voltage VEL-B applied to the organic EL element OLED for blue (B) is higher than the voltages VEL-R and VEL-G applied to the organic EL elements OLED for red (R) and green (G) respectively. This voltage difference is represented by ΔVEL.

As shown in FIG. 5 as well, the voltage difference ΔVEL is greatly affected by the material characteristics of the light emitting layers (EML). Normally, the voltages applied to the organic EL elements for the respective colors R, G, and B differ from one another. However, in the present embodiment, a description will be given of the case where only the voltage VEL-B applied to the organic EL element OLED for blue (B) is different from the voltages applied to the organic EL elements OLED for the other colors.

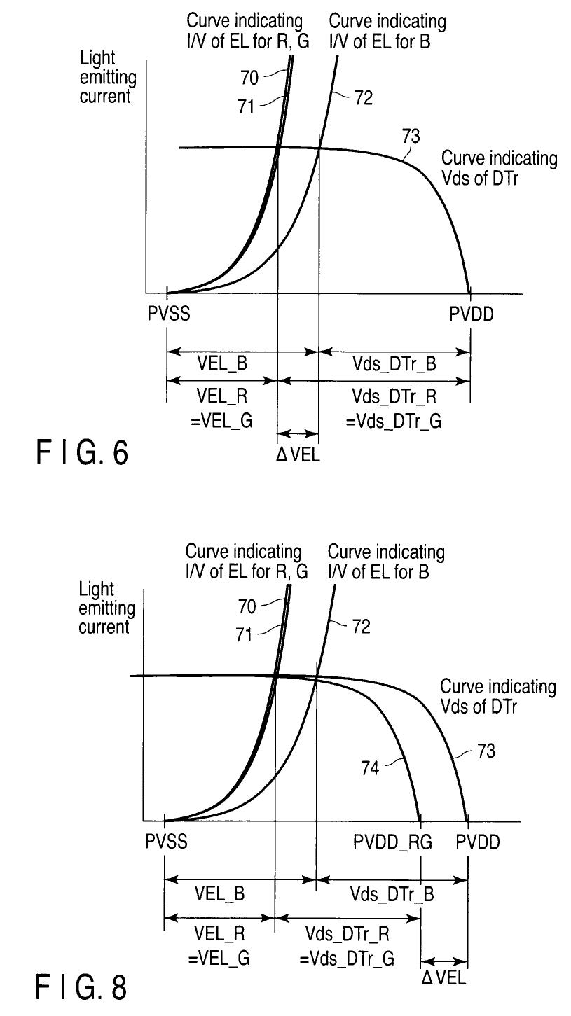

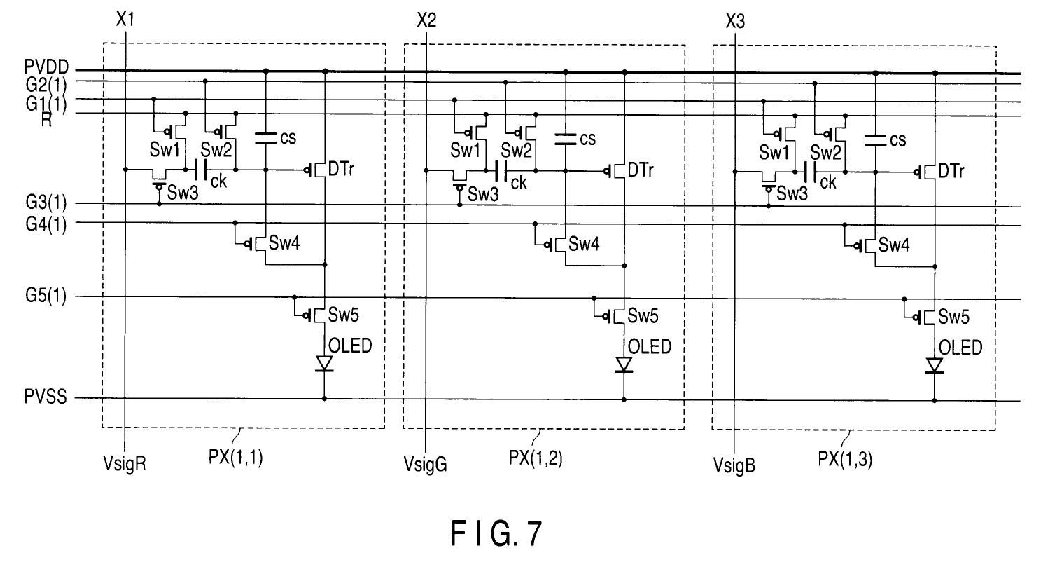

FIG. 6 is a conceptual diagram showing the light emission characteristics when a common high potential power source line (PVDD) is connected to the respective pixel circuits for R, G, and B. FIG. 7 is a diagram showing the configurations of the pixel circuits in which the common high potential power source line (PVDD) is connected to the respective pixel circuits for R, G, and B.

The vertical axis in FIG. 6 indicates light emission currents and the horizontal axis, voltages. The low potential PVSS and high potential PVDD are indicated on the horizontal axis. From the potentials on the horizontal axis, it can be seen how much voltage is distributed to the driving thin film transistor DTr and organic EL element OLED. Here, the wiring resistances are not taken into consideration.

Curves 70 and 71 indicate the current/voltage (I/V) of the organic EL elements for red (R) and green (G) respectively, and curve 72 indicates the current/voltage (I/V) of the organic EL element for blue (B). As described above, the organic EL elements for red (R) and green (G) exhibit curves with the same characteristics whereas the curve for the organic EL element for blue (B) is shifted toward the right in FIG. 6. Here, the horizontal axis for the curves 70, 71, and 72 indicates the anode-side voltage of the corresponding organic EL elements OLED.

Curve 73 represents the current/voltage (I/V) of the driving thin film transistor DTr. Since the pixel circuit in the present embodiment uses the saturation region for the driving thin film transistor DTr, the curves 70, 71, and 72 intersect with the curve 73 in the saturation region. The intersection point of the curve 73 with each of the curves 70, 71, and 72 indicates the light emission current flowing in the corresponding organic EL element OLED and the corresponding voltage at the time.

The saturation region of the curve 73 shifts vertically when the gate voltage of the driving thin film transistor DTr changes. Specifically, since the driving thin film transistor DTr is a P-channel transistor, the saturation region shifts downward as the gate voltage increases.

Incidentally, in FIG. 6, the voltages between the sources and drains of the corresponding driving thin film transistors DTr for red (R) and green (G), which are represented by Vds-DTr-R and Vds-DTr-G, are higher than the voltage between the source and drain of the driving thin film transistor DTr for blue (B), which is represented by Vds-DTr-B. This is because there is a voltage difference ΔVEL as described above. This can be interpreted as meaning that there is a power loss corresponding to the voltage difference ΔVEL.

FIG. 8 is a conceptual diagram showing the light emission characteristics of the organic EL elements in the pixel circuits in the present embodiment shown in FIG. 2.

While the blue pixel circuit is connected to the high potential power source line (PVDD), the red and green pixel circuits are connected to a high potential power source line (PVDD-RG), the potential of which is lower than that of the high potential power source line (PVDD) by ΔVEL. Curve 74 in FIG. 8 indicates a current/voltage (I/V) curve of the driving thin film transistor DTr connected to the high potential power source line (PVDD-RG). The upper limit of the curve 74 is indicated by a potential PVSS-RG, lower than the potential PVDD by ΔVEL. Like the curve 73, the curve 74 intersects with the curves 70, 71, and 72 in the saturation area. The explanation for FIG. 8 is the same as that for FIG. 6 and is therefore omitted.

The power used in each of the cases illustrated in FIGS. 6 and 8 is calculated.

Assuming the light emitting currents flowing in the organic EL elements OLED for the colors red (R), green (G), and blue (B) as I_R, I_G, and I_B respectively, the power W1 used in the case illustrated in FIG. 6 is expressed by the following equation (1):

W1=(PVDD−PVSS)×(I_{—}R+I_{—}G+I_{—}B) (1)

Power W2 used in the case illustrated in FIG. 8 is expressed by the following equation (2):

$$W 2 = ( PVDD - PVSS ) \times ( I\_B ) + ( PVDD\_RG - PVSS ) \times ( I\_R + I\_G ) \qquad ( 2 )$$

If the relation expressed by PVDD−PVDD_RG=ΔVEL is used, power reduction ΔW is expressed by the following equation (3):

ΔW=W1−W2=ΔVEL×(I_{—}R+I_{—}G) (3)

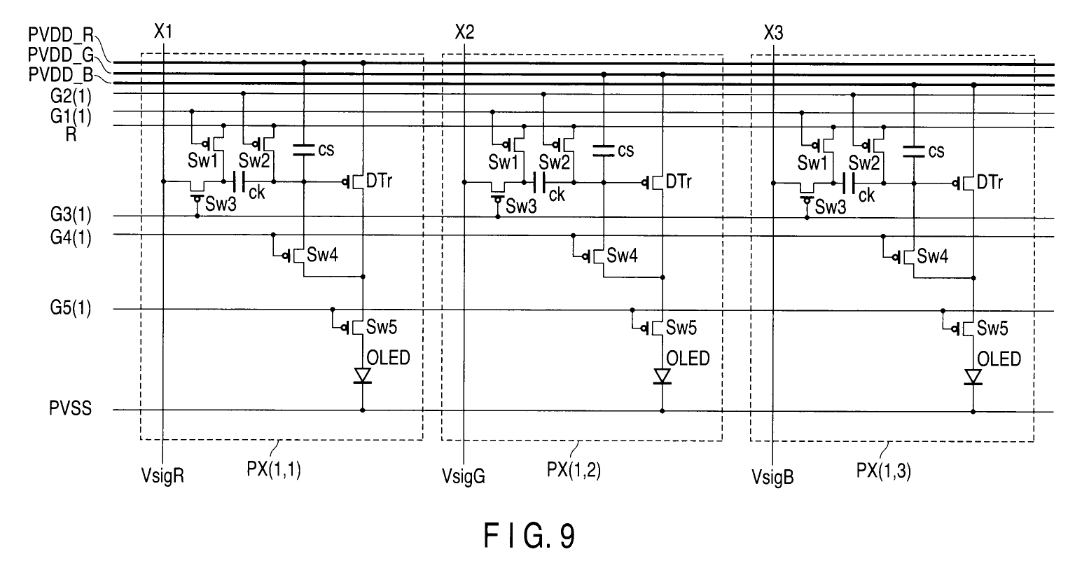

As described above, pixel circuits in the present embodiment reduce the power loss and cancel any offset caused by variation in the thresholds of the driving thin film transistors DTr. It is to be understood that the invention is not limited to the foregoing embodiment. As shown in FIG. 9, the potential of the high voltage power source line may be set for each of the organic EL elements assigned for the colors, as potentials PVDD_R, PVDD_G, and PVDD_B, respectively.

According to the characteristics of the organic EL elements OLED, the potential of the high voltage power source line for a pixel circuit assigned for one of the colors R, G, and B may be different from the potentials of the high voltage power source lines for the other colors.

The description of the foregoing embodiment assumes that all the thin film transistors composing each pixel circuit are of identical conductive type, namely the P-channel type. However, the invention is not limited to this and all the thin film transistors may be of an N-channel type. Additionally, each pixel circuit may be formed of thin film transistors of a different conductive type.

The description of the configuration of the pixel circuit in the foregoing embodiment assumes that the source and drain of the driving thin film transistor are used. However, the present invention is not limited to this embodiment. In the present invention, this description should be construed to mean that the source and drain refer to one (first) and the other (second) ends of the current path of the driving thin film transistor.

Further, the semiconductor layer of the thin film transistor need not be formed from polysilicon but may be formed from amorphous silicon. The self-light-emitting element composing each display pixel is not limited to the organic EL element, and various independently light emitting elements may also be used.

Furthermore, in the present embodiment, a voltage signal forms an image signal but the invention is not limited to this embodiment. A current signal may form an image signal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An active matrix type display apparatus comprising:
a plurality of pixels arranged in a matrix on a substrate, each pixel comprising:
a display element which is connected between a low potential power source line and a high potential power source line and emits light according to a light emitting current supplied to the display element;
a driving transistor which is connected between the high potential power source line and the display element and controls the light emitting current supplied to the display element according to a gate control voltage;
a first capacitor which is connected between a gate of the driving transistor and a first end of a current path of the driving transistor;
a second capacitor, a first end of an electrode of which is connected to the gate of the driving transistor;
a first switch which is connected between a second end of the electrode of the second capacitor and a reset line used for resetting the pixel and is on/off controlled by a control signal from a first control signal line used for controlling the pixel;
a second switch which is connected between the first end of the electrode of the second capacitor and the reset line and is on/off controlled by a control signal from a second control signal line used for controlling the pixel;
a third switch which is connected between the second end of the electrode of the second capacitor and an image signal line used for supplying the pixel with a signal corresponding to an image signal and is on/off controlled by a control signal from a third control signal line used for controlling the pixel;
a fourth switch which is connected between the gate of the driving transistor and a second end of the current path of the driving transistor and is on/off controlled by a control signal from a fourth control signal line used for controlling the pixel; and
a fifth switch which is connected between the second end of the current path of the driving transistor and the display element and is on/off controlled by a control signal from a fifth control signal line used for controlling the pixel; and
at least one power source which is disposed arbitrarily separately to correspond to a light emission color assigned to the display element and is connected to the high potential power source line.

2. The active matrix type display apparatus according to claim 1, wherein the high potential power sources are provided separately to correspond to the light emission colors.

3. The active matrix type display apparatus according to claim 1, wherein the high potential power sources are provided separately, one of the high potential power sources corresponding to one light emission color and the other one corresponding to the other light emission colors.

4. The active matrix type display apparatus according to claim 3, wherein the high potential power sources provided separately are different from each other in potential.

5. The active matrix type display apparatus according to claim 4, wherein the one light emission color is blue and the other light emission colors are red and green.

6. The active matrix type display apparatus according to claim 1, further comprising a control unit which supplies the control signal to each of the first to fifth control signal lines,
wherein during a horizontal scanning period, the control unit switches the pixel one after another to a reset period in which only the first and second switches are on, an offset cancellation period in which only the first and fourth switches are on, an image writing period in which only the third switch is on, or a light emitting period in which only the fifth switch is on.

7. The active matrix type display apparatus according to claim 6, wherein the high potential power sources are provided separately to correspond to the light emission colors.

8. The active matrix type display apparatus according to claim 6, wherein the high potential power sources are provided separately, one of the high potential power sources corresponding to one light emission color and the other one corresponding to the other light emission colors.

9. The active matrix type display apparatus according to claim 8, wherein the high potential power sources provided separately are different from each other in potential.

10. The active matrix type display apparatus according to claim 9, wherein the one light emission color is blue and the other light emission colors are red and green.

11. An active matrix type display apparatus comprising:
a plurality of pixels arranged in a matrix on a substrate, each pixel comprising:
a display element which is connected between a low potential power source line and a high potential power source line and emits light according to a light emitting current supplied to the display element;
a driving transistor which is connected between the high potential power source line and the display element and controls the light emitting current supplied to the display element according to a gate control voltage;
a first capacitor which is connected between a gate of the driving transistor and a first end of a current path of the driving transistor;
a second capacitor, a first end of an electrode of which is connected to the gate of the driving transistor;
a first switch which is connected between a second end of the electrode of the second capacitor and a reset line used for resetting the pixel and is on/off controlled by a control signal from a first control signal line used for controlling the pixel;
a second switch which is connected between the first end of the electrode of the second capacitor and the reset line and is on/off controlled by a control signal from a second control signal line used for controlling the pixel;
a third switch which is connected between the second end of the electrode of the second capacitor and an image signal line used for supplying the pixel with a signal corresponding to an image signal and is on/off controlled by a control signal from a third control signal line used for controlling the pixel;
a fourth switch which is connected between the gate of the driving transistor and a second end of the current path of the driving transistor and is on/off controlled by a control signal from a fourth control signal line used for controlling the pixel; and
a fifth switch which is connected between the second end of the current path of the driving transistor and the display element and is on/off controlled by a control signal from a fifth control signal line used for controlling the pixel; and
at least two power sources which are disposed separately, one of the power sources corresponding to one light emission color assigned to the display element and the other one corresponding to the other light emission colors assigned to the other display elements and which are connected to the two high potential power source lines separately.

12. An active matrix type display apparatus comprising:
a plurality of pixels arranged in a matrix on a substrate, each pixel comprising:
a display element which is connected between a low potential power source line and a high potential power source line and emits light according to a light emitting current supplied to the display element;
a driving transistor which is connected between the high potential power source line and the display element and controls the light emitting current supplied to the display element according to a gate control voltage;
a first capacitor which is connected between a gate of the driving transistor and a first end of a current path of the driving transistor;
a second capacitor, a first end of an electrode of which is connected to the gate of the driving transistor;
a first switch which is connected between a second end of the electrode of the second capacitor and a reset line used for resetting the pixel and is on/off controlled by a control signal from a first control signal line used for controlling the pixel;
a second switch which is connected between the first end of the electrode of the second capacitor and the reset line and is on/off controlled by a control signal from a second control signal line used for controlling the pixel;
a third switch which is connected between the second end of the electrode of the second capacitor and an image signal line used for supplying the pixel with a signal corresponding to an image signal and is on/off controlled by a control signal from a third control signal line used for controlling the pixel;
a fourth switch which is connected between the gate of the driving transistor and a second end of the current path of the driving transistor and is on/off controlled by a control signal from a fourth control signal line used for controlling the pixel; and
a fifth switch which is connected between the second end of the current path of the driving transistor and the display element and is on/off controlled by a control signal from a fifth control signal line used for controlling the pixel; and
a power source which is shared between the light emission colors assigned to the corresponding display elements and is connected to the high potential power source line.

13. An active matrix type display apparatus comprising:
a plurality of pixels arranged in a matrix on a substrate, each pixel comprising:
a display element which is connected between a low potential power source line and a high potential power source line and emits light according to a light emitting current supplied to the display element;
a driving transistor which is connected between the high potential power source line and the display element and controls the light emitting current supplied to the display element according to a gate control voltage;
a first capacitor which is connected between a gate of the driving transistor and a first end of a current path of the driving transistor;
a second capacitor, a first end of an electrode of which is connected to the gate of the driving transistor;
a first switch which is connected between a second end of the electrode of the second capacitor and a reset line used for resetting the pixel and is on/off controlled by a control signal from a first control signal line used for controlling the pixel;
a second switch which is connected between the first end of the electrode of the second capacitor and the reset line and is on/off controlled by a control signal from a second control signal line used for controlling the pixel;
a third switch which is connected between the second end of the electrode of the second capacitor and an image signal line used for supplying the pixel with a signal corresponding to an image signal and is on/off controlled by a control signal from a third control signal line used for controlling the pixel;
a fourth switch which is connected between the gate of the driving transistor and a second end of the current path of the driving transistor and is on/off controlled by a control signal from a fourth control signal line used for controlling the pixel; and
a fifth switch which is connected between the second end of the current path of the driving transistor and the display element and is on/off controlled by a control signal from a fifth control signal line used for controlling the pixel; and
a plurality of power sources which are provided separately to correspond to light emission colors assigned to the corresponding display elements and are connected to the corresponding high potential power source lines.
